(19) United States
(12) Patent Application Publication
(10) Pub. No.: US 2016/0225495 A1
(43) Pub. Date: Aug. 4, 2016

(54) Insulation System for a Tool and Tool having Same

(71) Applicant: ROBERT BOSCH GMBH, Stuttgart (DE)

(72) Inventors: Achim Kugler, Gschwend (DE); Joerg Schneider, Fichtenberg (DE)

(21) Appl. No.: 15/021,646

(22) PCT Filed: Jul. 8, 2014
(86) PCT No.: PCT/EP2014/064507

§ 371 Date: Mar. 11, 2016

(30) Foreign Application Priority Data
Sep. 11, 2013 (DE) 10 2013 218 150.7

(51) Int. Cl. H01B 17/42; B25G 1/12; H01B 17/62; B25F 5/02

(52) U.S. Cl. CPC H01B 17/42; B25F 5/02; B25G 1/12; H01B 17/62

(57) ABSTRACT

An insulation system for a tool includes a first element that is configured to electrically insulate the tool relative to a tool output. The tool output has a detachably mountable tool element of the tool configured for machining a workpiece. A tool includes the insulation system.

The present invention relates to an insulation system for a tool and a tool equipped with said insulation system.

In the automotive industry, tools such as screwdrivers are used when installing batteries in electric vehicles. The batteries are generally accumulators that consist of a plurality of elements which have to be screwed to one another. Here, the screws also have to be screwed in on live parts. During this process, the protection of an operator of the tool against electrical voltages must be ensured, these voltages posing a danger to the operator.

This is currently implemented by way of example by an insulation tape winding of the tool. However, this is very complex and susceptible to faults. In addition, only the contact of live parts can be avoided hereby. At the least, however, an introduction of the electrical voltages from the workpiece to be worked on into the tool cannot be prevented.

The object of the present invention is therefore to provide an insulation system for a tool and a tool equipped with said insulation system, by means of which the aforementioned problems can be solved. In particular, an insulation system for a tool and a tool equipped with said insulation system are to be provided, with which both the tool and also the operator thereof are protected against electrical voltages occurring at a workpiece to be worked on with the tool.

This problem is solved by an insulation system for a tool as claimed in claim 1.

Advantageous further embodiments of the insulation system are specified in the dependent claims.

The insulation system for a tool offers a convincing overall concept which ensures that both the tool and operator thereof are protected against electrical voltages occurring at a workpiece to be worked on with the tool. An overall solution for example of a screw system for category A screw connections is thus provided which makes it possible to work under “live working” conditions.

The insulation system can be easily retrofitted and can thus be used with any standard screwdriver. This is also advantageous for a user of the tool in respect of spare parts management.

The insulation system offers a simple and manageable solution to the aforementioned problem. The insulation system contributes to a high process safety of the tool.

The object is additionally solved by a tool as claimed in claim 7.

Advantageous further embodiments of the tool are specified in the dependent claims.

The tool attains the same advantages as discussed previously in relation to the insulation system.

Further possible implementations of the invention also include combinations not explicitly mentioned of features or embodiments described above or hereinafter with regard to the exemplary embodiment. Here, a person skilled in the art will also add individual details as improvements or supplementations to the respective basic form of the invention.

The invention will be described in greater detail hereinafter with reference to the accompanying drawing and on the basis of an exemplary embodiment. In the drawing:

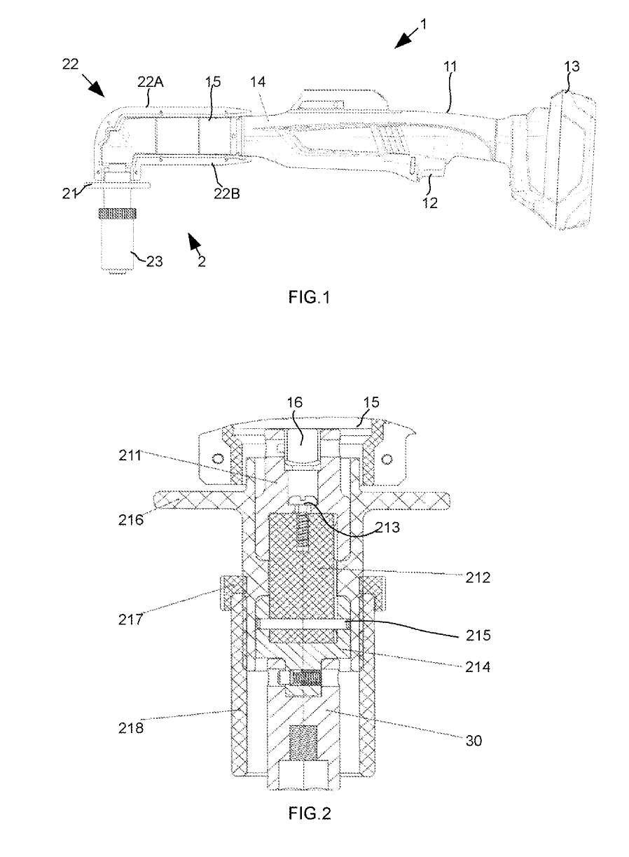

FIG. 1 shows a side view of a tool having an insulation system in accordance with an exemplary embodiment; and

FIG. 2 shows a sectional view of a tool according to the exemplary embodiment.

In the figures, like or functionally similar elements are provided with the same reference signs, unless otherwise specified.

FIG. 1 shows a tool 1 having an insulation system 2. The tool 1 may be a screwdriver, a riveting tool, a punching tool, a nail gun, etc. The tool 1 in FIG. 1 is a tool that can be hand-held. However, the tool 1 is not limited hereto. The tool 1 may also be a stationary tool.

In FIG. 1 the tool 1 has a handle 11, an on/off switch 12, a battery compartment 13, a housing 14, and a drive unit 15. A battery, such as a rechargeable accumulator or a non-rechargeable battery, can be received in the battery compartment 13. The tool 1 is thus a cordless tool. The housing 13 is fabricated from a material, for example plastic, etc., that is electrically insulating. The tool 1, in the region of the housing 13, thus has a surface made of an electrically insulating material. However, the tool 1 has, at the drive unit 15, a metal housing, in particular a steel housing. The drive unit 15 thus has an electrically conductive housing.

The insulation system 2 in FIG. 1 has a first element and as second element 22 two housing parts 22A, 22B made of an electrically insulating material, such as plastic, etc. In particular, the two housing parts 22A, 22B are two insulating half-shells, which surround the metal housing of the angle drive, more specifically the drive unit 15, as shown in FIG. 1. The two housing parts 22A, 22B are connected to one another by fastening elements attached in a recessed manner, for example screws, etc.

The first element 21 is fastened to the drive unit 15 in FIG. 1. In particular, an electrically insulated and electrically insulating extension can be received on a square of the drive unit 15 as first element 21 with integrated hexagonal socket wrench and in particular can be latched in position. The first element 21 is illustrated in greater detail in FIG. 2.

As shown in FIG. 2, a drive flange 211 is fitted on the output square of the drive unit 15 of the tool 1 and held by the detent pin 16 thereof. An insulation piece 212 is arranged in the drive flange 211 and sits in place for example with the aid of an interlocking toothing (not illustrated). As a result of this insulation piece 212, the working point at a workpiece is electrically separated from the tool 1. Axial securing is provided via a first fastening element 213, for example in the form of a screw.

On the output side, the insulation piece 212 in FIG. 2 is received in the output flange 214, again by means of an interlocking toothing. Axial securing is provided here by a second fastening element 215 in the form of a roll pin. A commercial hex key as tool element 30 can now be fitted onto the output square of the output flange 214. The output square of the output flange 214 can thus also be referred to as a receiving element for releasably receiving the tool element 30.

The outer insulation of the first element 21 is provided by the components 216, 217 and 218 made of an electrically insulating material, such as plastic, etc. The components 216, 217 and 218 comprise an insulating sleeve 216, a retaining ring 217 and a screw sleeve 218.

The desired additional electrical insulation of the tool 1 with respect to electrical voltages at a workpiece to be worked with the tool 1 can thus be provided by the insulation system 2.

In accordance with a second exemplary embodiment, the covering of the screwdriver socket, i.e. of the hex key 30, can be adjusted by twisting the screw sleeve 218 to a greater or lesser extent and can be secured by means of the retaining ring 217. The operator of the tool 1 thus has the option to himself set a maximum possible covering with the necessary accessibility to the screwing location.

Otherwise, the tool 1 and insulation system 2 thereof are constructed in the present exemplary embodiment in a manner identical to that described with reference to the first exemplary embodiment.

In accordance with a third exemplary embodiment the components 216, 217 and 218 are not fixedly connected to the output shaft, which is formed from the components 211, 212, 214, 30. This means that the components 216, 217 and 218 in the event of normal operation are frictionally coupled and rotate with the output shaft formed from the components 211, 212, 214, 30. However, the components 216, 217 and 218 remain still when contacted. Consequently, the components 216, 217 and 218 are arranged freely rotatably. The components 216, 217 and 218 can therefore prevent injuries to the operator of the tool 1, which may be caused for example if an item of the operator's clothing is reeled in at the tool 1 and/or insulation system 2 thereof.

Otherwise, the tool 1 and insulation system 2 thereof are constructed in the present exemplary embodiment in a manner identical to that described with reference to the first exemplary embodiment.

In accordance with a fourth exemplary embodiment the first element 21 is embodied such that the first element 21 cannot be removed from the second element 22 without disassembly. A design of this type prevents the simple, for example tool-free, modification of the insulated output by an operator of the tool 1. The safety for the tool 1 and operator thereof can thus be further increased.

Otherwise, the tool 1 and insulation system 2 thereof are constructed in the present exemplary embodiment in a manner identical to that described with reference to the first exemplary embodiment.

All of the previously described embodiments of the tool 1 and of the insulation system 2 can be used individually or in all possible combinations. In particular, all features and/or functions of the previously described exemplary embodiments can be combined arbitrarily. In addition, the following modifications in particular are conceivable.

The parts illustrated in the figures are illustrated schematically and may deviate in the actual embodiment from the forms shown in the figures, provided the previously described functions thereof are ensured.

Where necessary the first fastening element 213 can also be embodied other than as a screw. The second fastening element 215, where necessary, may also be embodied other than as a roll pin, and for example can be embodied by a screw. Fastenings in the form of welded connections, glued connections, a snap-fit connection, etc. are also possible for both fastening elements 213, 215.

1. An insulation system for a tool, comprising:
a first element configured to electrically insulate the tool with respect to a tool output, the tool output including a detachably mountable tool element of the tool configured to work on a workpiece.

2. The insulation system as claimed in claim 1, further comprising a second element configured to electrically insulate metal parts of a drive unit of the tool.

3. The insulation system as claimed in claim 2, wherein the second element is configured such that the tool output is removable only with disassembly of the second element from the tool.

4. The insulation system as claimed in claim 2, wherein the second element is configured to surround a steel housing of the drive unit of the tool, and wherein the second element comprises two half-shells configured to surround the steel housing of the drive unit of the tool, the two half-shells made of electrically insulating material.

5. The insulation system as claimed in claim 1, wherein the first element is an electrically insulated and insulating element integrated with a receiving element configured to releasably receive the tool element.

6. The insulation system as claimed in claim 1, wherein the first element has components configured to electrically insulate the tool output from the exterior, and wherein the components are arranged freely rotatably relative to an output shaft.

7. A tool, comprising:
a drive configured to drive a tool element that is detachably mountable at an output of the drive unit; and
a first element configured to electrically insulate the tool relative to the output.

8. The tool as claimed in claim 7, further comprising a second element configured to electrically insulate metal parts of the tool output.

9. The tool as claimed in claim 1, wherein the tool is a cordless tool.

10. The tool as claimed in claim 1, wherein the tool is a screwdriver or riveting tool or punching tool.
